(19) United States
(12) Patent Application Publication
(10) Pub. No.: US 2008/0060675 A1
(43) Pub. Date: Mar. 13, 2008

(54) Method and apparatus for dispensing oral hygiene products

(75) Inventors: Richard G. Keiser, New York, NY (US); Philip J. Angileri, Bridgewater, MA (US)

Correspondence Address: WOLF GREENFIELD & SACKS, P.C., 600 ATLANTIC AVENUE, BOSTON, MA, 02210-2206, US

(73) Assignee: Richard G. Keiser, New York, NY (US)

(21) Appl. No.: 11/518,769

(22) Filed: Sep. 11, 2006

(51) Int. Cl. A61C 15/00

(52) U.S. Cl. 132/322

(57) ABSTRACT

A method and apparatus for cleansing a person's mouth. One aspect is an apparatus comprising at least one teeth cleaning tool, a volume of mouth rinse and a container. The container comprises at least one first chamber that is liquid-tight and has the volume of mouth rinse disposed therein. The container further comprises at least one second chamber having the at least one teeth cleaning tool at least partially disposed therein.

### FIELD OF THE INVENTION

The present invention is directed to the field of portable hygiene dispensers.

### BACKGROUND OF THE INVENTION

At present, several products are associated with oral hygiene, including toothpaste, toothbrushes, dental floss and fluoride rinses. In many situations, it is either impractical or inconvenient to carry one or more of these products on one's person for use after a meal or snack.

### SUMMARY OF THE INVENTION

One illustrative embodiment is directed to an apparatus comprising at least one teeth cleaning tool; a volume of mouth rinse and a container. The container comprises at least one first chamber that is liquid-tight and has the volume of mouth rinse disposed therein; and at least one second chamber having the at least one teeth cleaning tool at least partially disposed therein.

Another embodiment is directed to a method of cleansing the mouth of a person. The method comprises acts of: (A) taking a portable mouth cleansing apparatus along with the person when the person leaves a location to which the person will return to go to sleep the next time the person goes to sleep, the mouth cleaning apparatus comprising a volume of mouth rinse and at least one teeth cleaning tool; and (B) while away from the location to which the person will return to go to sleep, using the apparatus to cleanse the person's mouth by rinsing the person's mouth with at least some of the volume of mouth rinse; and/or using the at least one teeth cleaning tool to at least partially clean the person's teeth.

Another embodiment is directed to a method of cleansing the mouth of a student attending school for a portion of a day and then returning to the student's home. The method comprises acts of: (A) taking a portable mouth cleansing apparatus along with the student when the student leaves the student's home for school, the mouth cleaning apparatus comprising a volume of mouth rinse and at least one teeth cleaning tool; and (B) while at school, using the apparatus to cleanse the student's mouth by rinsing the student's mouth with at least some of the volume of mouth rinse; and/or using the at least one teeth cleaning tool to at least partially clean the student's teeth.

### BRIEF DESCRIPTION OF THE DRAWINGS

FIG. 1 is a side view of a portable hygiene dispenser according to one illustrative embodiment of the invention;

FIG. 2 is a front view of the portable hygiene dispenser of FIG. 1;

FIG. 3 is a cross-section view of one chamber of the portable hygiene dispenser of FIGS. 1-2;

FIG. 4 is a cross-section view of a cap to seal liquid in one chamber of the portable hygiene dispenser of FIGS. 1-3;

FIG. 5 is a cross-sectional view of a second chamber of the portable hygiene dispenser of FIGS. 1-3;

FIG. 6 is a front view of a second chamber of the portable hygiene dispenser of FIGS. 1-3

FIG. 7 is an exploded view of parts of the portable hygiene dispenser of FIGS. 1-6, according to one illustrative embodiment of the invention;

FIG. 8 is an exploded view of a portable hygiene dispenser, according to a second illustrative embodiment of the invention

FIG. 9 is a side view of a first side of a portable hygiene dispenser, according to a third illustrative embodiment of the invention;

FIG. 10 is a front view of the portable hygiene dispenser of FIG. 9;

FIG. 11 is a side view of a second side, opposite the first, of the portable hygiene dispenser of FIGS. 9-10;

FIG. 12 is a side view of the first side of the main body of the portable hygiene dispenser of FIGS. 9-11;

FIG. 13 is a cross section view of the main body of the portable hygiene dispenser of FIGS. 9-11;

FIG. 14 is a side view of the second side of the main body of the portable hygiene dispenser of FIGS. 9-11;

FIG. 15 is a front view of one chamber cover of the portable hygiene dispenser of FIGS. 9-11;

FIG. 16 is a side view of the chamber cover of the portable hygiene dispenser of FIGS. 9-11;

FIG. 17 is a side view of one outer cover of the portable hygiene dispenser of FIGS. 9-11;

FIG. 18 is a front view of the outer cover of the portable hygiene dispenser of FIGS. 9-11;

FIG. 19 is a side view of the second outer cover of the portable hygiene dispenser of FIGS. 9-11;

FIG. 20 is a front view of the second cover of the portable hygiene dispenser of FIGS. 9-11;

FIG. 21 is a side view of a cap to seal liquid in one chamber of the portable hygiene dispenser of FIGS. 9-11;

FIG. 22 is a side view of a dental floss cutter of the portable hygiene dispenser of FIGS. 9-11;

FIG. 23 is one exploded view of several parts of the portable hygiene dispenser of FIGS. 9-22;

FIG. 24 is a second exploded view of several parts of the portable hygiene dispenser of FIGS. 9-22;

### DETAILED DESCRIPTION

In many situations it is impractical or inconvenient to carry one or more of the products commonly associated with oral care (e.g., toothpaste, toothbrush, dental floss, and fluoride rinses). One embodiment of the present invention is directed to a pocket-sized, portable device that can dispense two or more products related to oral care, hygiene and/or health, including those referenced above.

One aspect of the invention is directed to a portable dispenser comprised of two separate chambers, one of which can be fully sealed to contain and transport a liquid mouth rinse and the other of which can be arranged to enclose a teeth cleaning tool (e.g., dental floss, a toothpick, or a toothbrush). Numerous configurations of such a dispenser are possible, and the present invention is not limited to any particular configuration. The embodiments described below are specially adapted for use with dental floss as the teeth cleaning tool, but it should be appreciated that the invention is not limited in this respect.

In one embodiment, a nozzle with a resealable cap may be incorporated into the dispenser to dispense the liquid and reseal the chamber. Alternatively, another embodiment is directed to a one-time use product on which a breakable seal or nozzle may be incorporated.

In another embodiment, the body of the device that is integral with the chamber designed to contain the liquid may optionally include features to facilitate the transportation or dispensing of the dental floss.

The liquid mouth rinse used can take any suitable form, as the aspects of the present invention are not limited to any particular type of mouth rinse. In accordance with one embodiment of the present invention, the mouth rinse has a viscosity that is sufficiently low (e.g., below 100 centipoise) to enable the mouth rinse to rinse out the mouth of a user without requiring an applicator tool of any type. The mouth rinse may have one or more active ingredients, examples of which include sodium fluoride, sodium peroxide, cetylpyridinium chloride, eucalyptol, menthol, menthyl salicylate and thymol, although the present invention is not limited in this respect. As stated above, while a mouth rinse including one or more of these active ingredients may advantageously be employed in accordance with one embodiment of the present invention, the aspects of the present invention described herein are not limited to any particular type of mouth rinse.

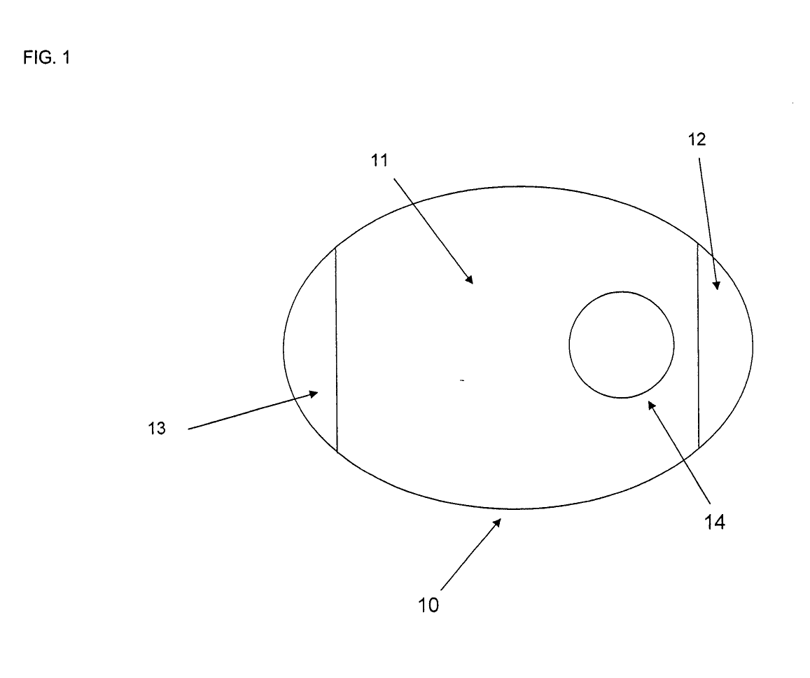

One illustrative embodiment of a hygiene dispenser 10 is shown in FIGS. 1-7. FIG. 1 shows a side view of the hygiene dispenser 10. In this embodiment, a chamber 11 is designed to transport and dispense liquid, a cap 13 is designed to seal one opening of chamber 11, and a chamber 12 is designed to enclose and dispense a teeth cleaning tool, such as dental floss. In one illustrative example, an indented feature 14 has been incorporated into the outer wall of chamber 11 to indicate where an individual might apply pressure, thereby facilitating the dispensing of liquid, although such a feature is not required. In one embodiment, the dispenser is small enough to be portable (e.g., the dispenser may be sized with no dimension greater than four inches and more preferably no dimension greater than three inches), although all embodiments of the present invention are not limited in this respect.

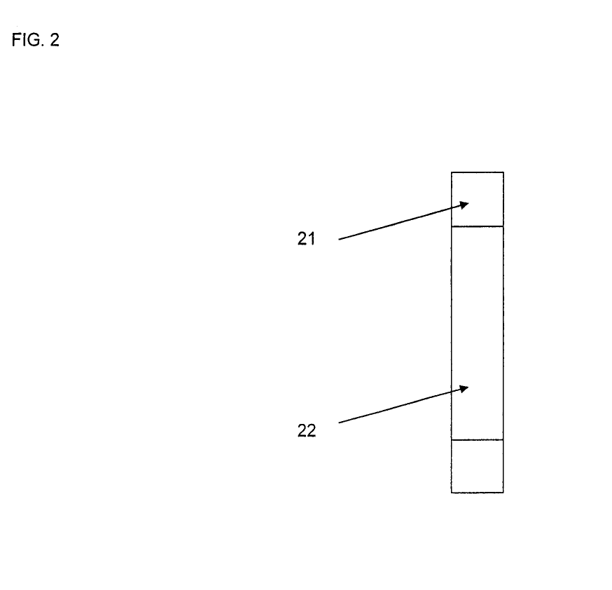

FIG. 2 shows a front view of the hygiene dispenser 10 showing the front 22 of the cap 13 and the front 21 of the chamber 11.

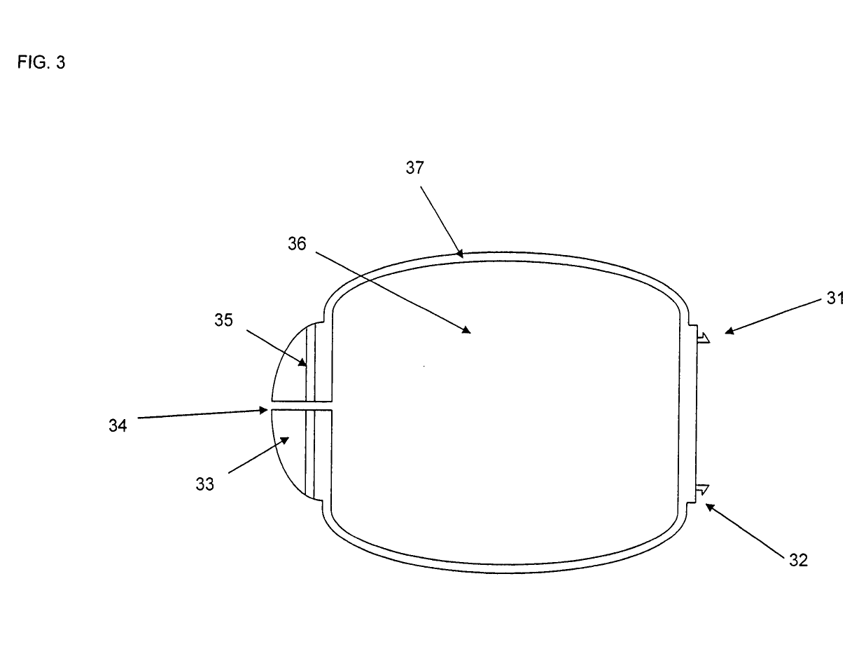

FIG. 3 shows a cross-section of the chamber 11. A wall 37 of chamber 11 is designed to form a cavity 36 to transport liquid. In this embodiment, the chamber 11 has an opening 34 incorporated into feature 33 of outer wall 37 at one end to dispense the liquid from the cavity 36. As represented, feature 33 is shaped to be comfortable against or at least partially inside the mouth of the user of the product. It should be appreciated that other arrangements (e.g., a circular opening into which a nozzle may be secured) can be implemented to transport and/or dispense the liquid, as the present invention is not limited in this respect.

Feature 33 includes a ridge 35 that serves as an attachment point for cap 13. Similarly, two raised features 31 and 32 are incorporated into the outer wall 37 of chamber 11 at the opposite end and serve as attach points for the second chamber 12. Any suitable mechanisms for attachment can be used for the cap 13 and chamber 12, as the invention is not limited in this respect.

In one embodiment, chamber wall 37 is made of a flexible material, such as plastic, which a user can squeeze to facilitate the dispensing of the liquid. However, the invention is not limited in this respect. As an alternative to carrying liquid directly, chamber 11 can enclose a sealed liquid pouch (with or without an attached nozzle).

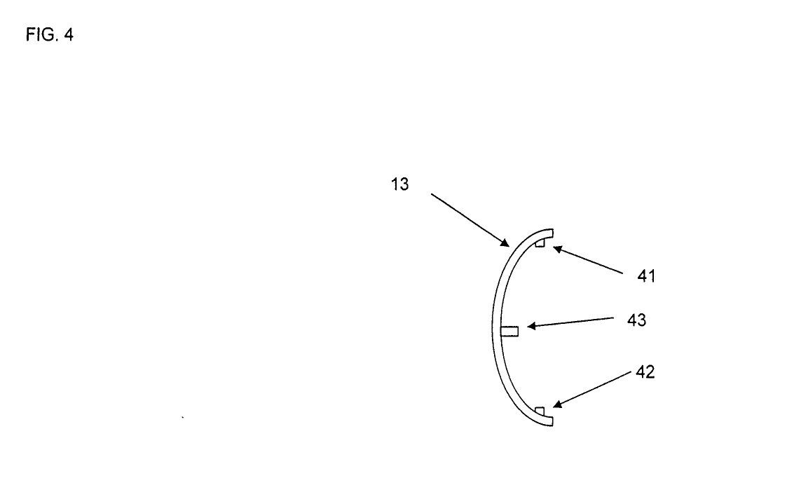

FIG. 4 shows a cross-sectional view of one embodiment of cap 13. In this embodiment, nubs 41 and 42 are incorporated into the design to enable the cap 13 to attach to ridge 35 in feature 33 of the outer wall 37 of chamber 11. Nub 43 matches the opening 34, thereby sealing liquid in cavity 36 when the cap 13 is attached to chamber 11. It should be appreciated that there are numerous ways of creating a seal with a cap (e.g., a snap fit, screw-on fit, retractable and sealable sport nozzle), and any of these or other suitable configurations can be used instead of the configuration shown in FIGS. 3 and 4. Alternatively, as previously discussed, in the embodiment directed to a one-time use product, a removable or breakable cap can be used to create an opening to the chamber containing the liquid.

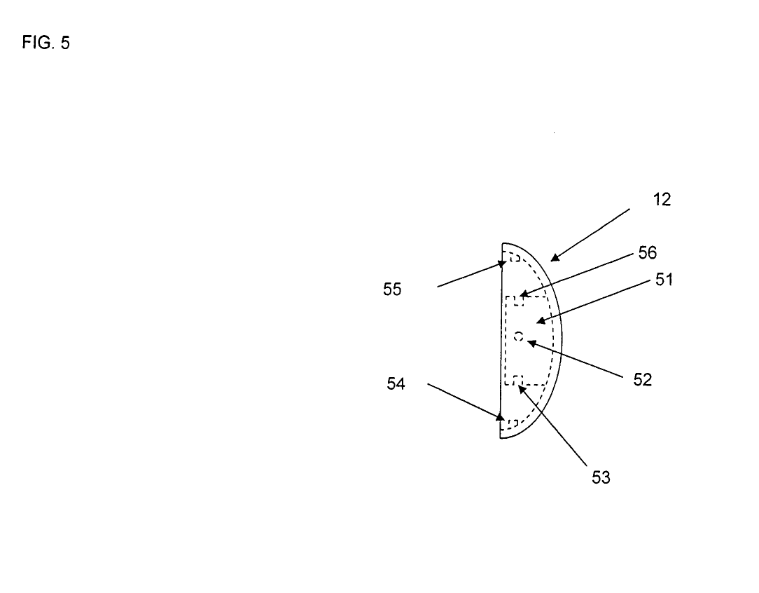

FIG. 5 shows a cross-sectional view of second chamber 12. Chamber 12 has nubs 54 and 55 that match features 31 and 32 to secure the second chamber 12 to the chamber 11. It should be appreciated that other attachment techniques are possible. In the embodiment of FIG. 5, solid feature 51 has been incorporated into the inner wall of chamber 12. Feature 51 includes several features to enable the transportation and dispensing of dental floss. For example, in this embodiment, hole 52 serves as a point where the dental floss can be tied or secured to chamber 12. Ridges 53 and 56 provide an area around which dental floss can be wound.

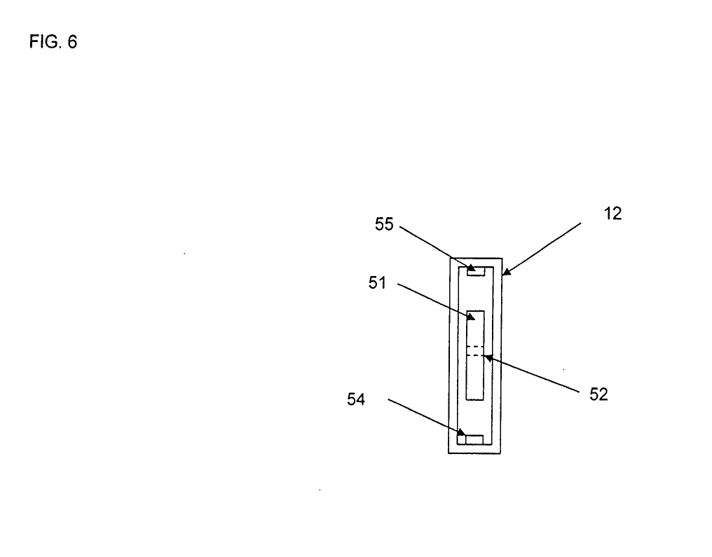

FIG. 6 shows a front-view of the same chamber 12. In this view solid feature 51 is more visible and it can be appreciated how dental floss could be secured in hole 52 and wound around solid feature 51. It should be understood that the present invention is not intended to limit the function of chamber 12 to carrying dental floss. For example, if solid feature 51 were omitted, chamber 12 could serve to transport toothpicks or other small solid hygienic products.

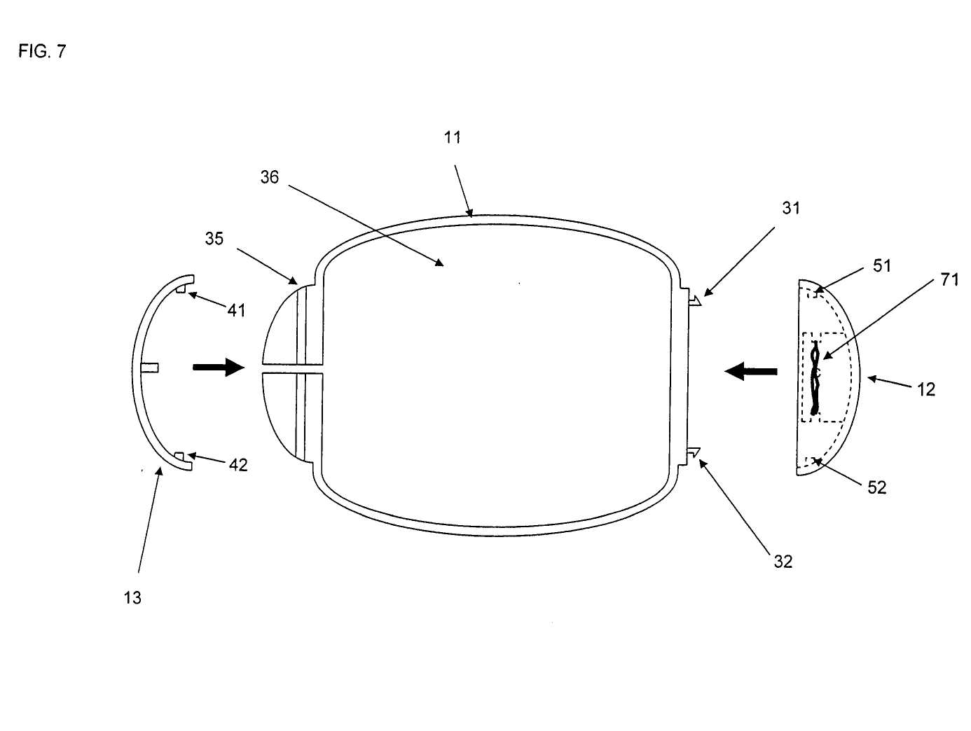

FIG. 7 shows the three components previously described, and illustrates how they can be secured to create the dispenser 10. Cap 13 is secured to chamber 11 via nubs 41 and 42 to create a closed and secure compartment for transporting and dispensing the liquid in cavity 36. Second chamber 12 is secured to the outer wall of chamber 11 via nubs 51 and 52 which match features 31 and 32, thereby enclosing dental floss 71 and creating the assembled dispenser 10.

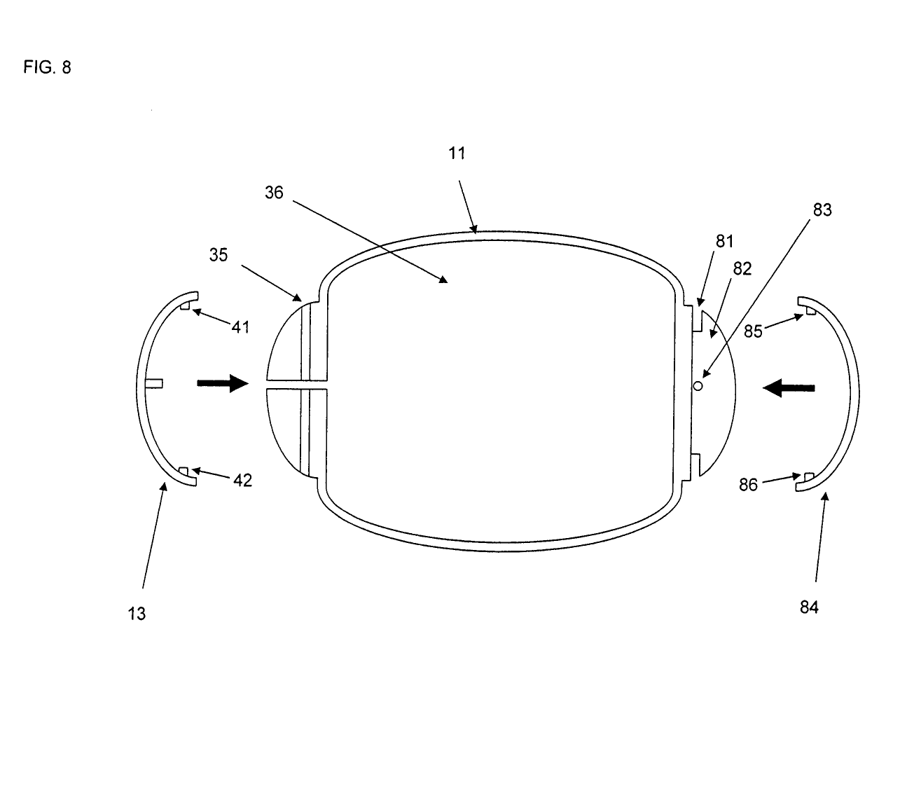

FIG. 8 shows an alternate illustrative embodiment. In this embodiment, some features relating to the transporting and dispensing of liquid are identical to those of the embodiment of FIGS. 1-7. However, features for securing and dispensing dental floss have been incorporated into the body of the device that includes chamber 11, and the second chamber is created by attaching cover 84. As shown in FIG. 8, solid feature 82 is incorporated into the body of the device (integral with the outer wall of chamber 11). Feature 82 includes several features to enable the transportation and dispensing of dental floss. Hole 83 serves as a point where the dental floss could be tied or secured. Ridge 81 provides an area around which dental floss could be wound. Attach points 85 and 86 enable cover 84 to be secured to chamber 11, creating the second chamber.

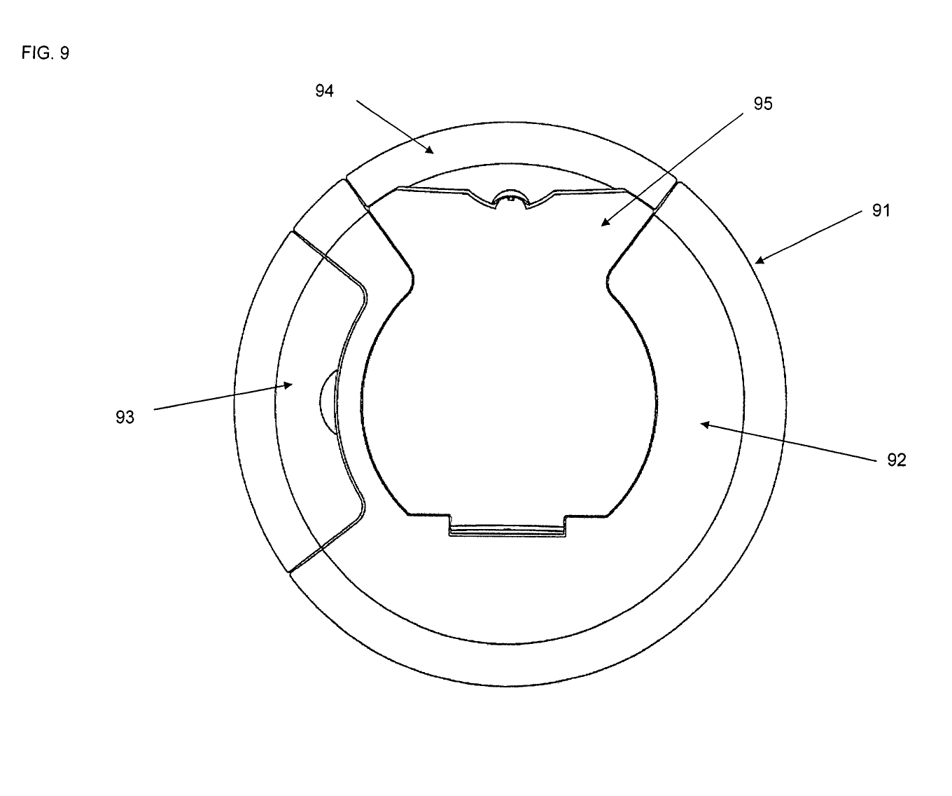

A third illustrative embodiment of the invention is shown in FIGS. 9-24. In this embodiment, the first chamber designed to transport and dispense liquid is fully integrated into a main body, and the second chamber designed to at least partially enclose and dispense a teeth cleaning tool is formed by a cavity incorporated into the main body and a moveable chamber cover.

FIG. 9 shows a side view of the hygiene dispenser 91 and its main components: main body 92, chamber cover 95, pull off cap 93, and hinged cap 94. It should be understood that having one hinged cap and one pull-off cap is not central to the invention, and alternatives are possible (e.g., two hinged caps, two pull-off caps, caps that snap into place, etc.).

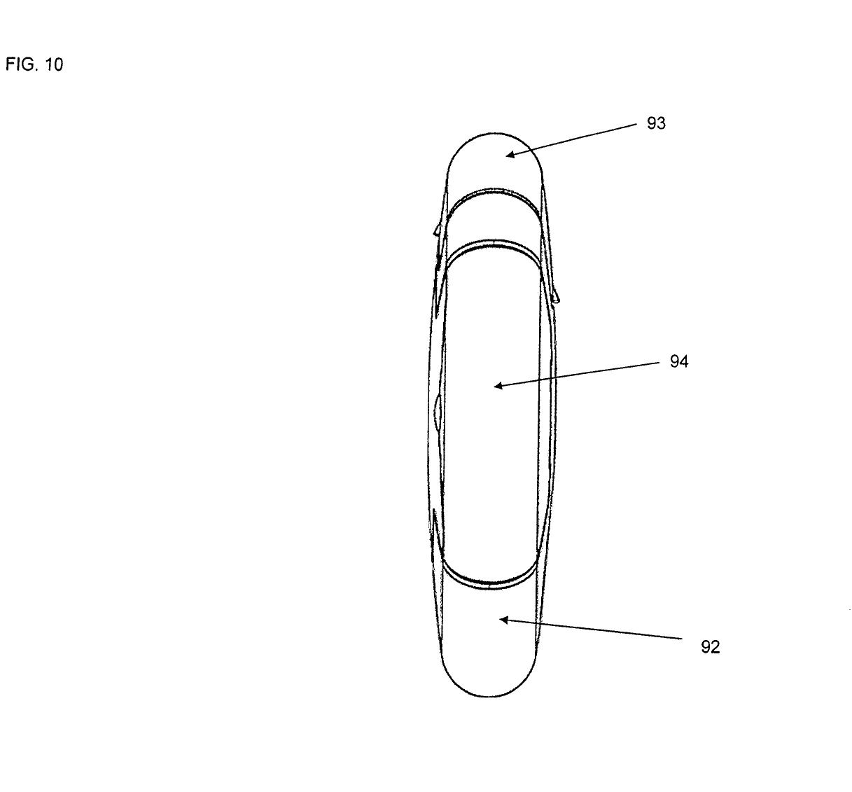

FIG. 10 shows a front view of same hygiene dispenser 91 with pull off cap 93 and hinged cap 94 attached to main body 92.

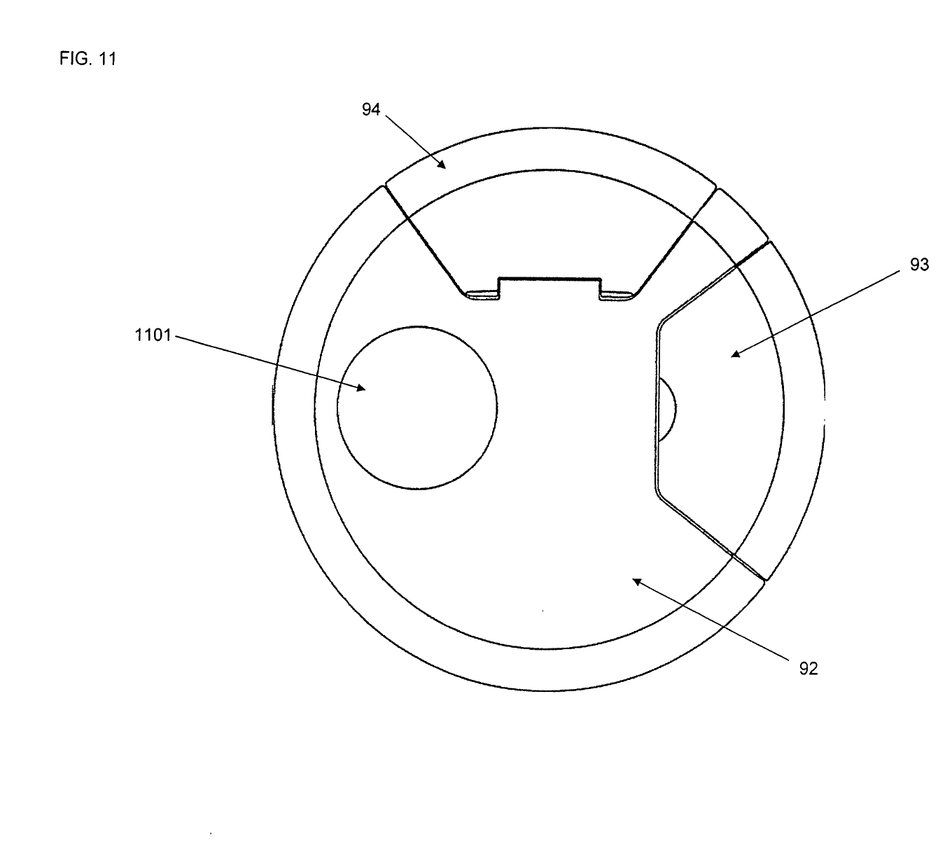

FIG. 11 shows a side view of the opposite side (i.e., opposite to the side shown in FIG. 9) of hygiene dispenser 91. In this view, the opposite sides of hinged cap 94 and pull off cap 93 are visible, as well as optional indented feature 1101, incorporated into main body 92, to indicate a point where pressure can be applied to facilitate the flow of liquid out of the first chamber fully integrated into main body 92.

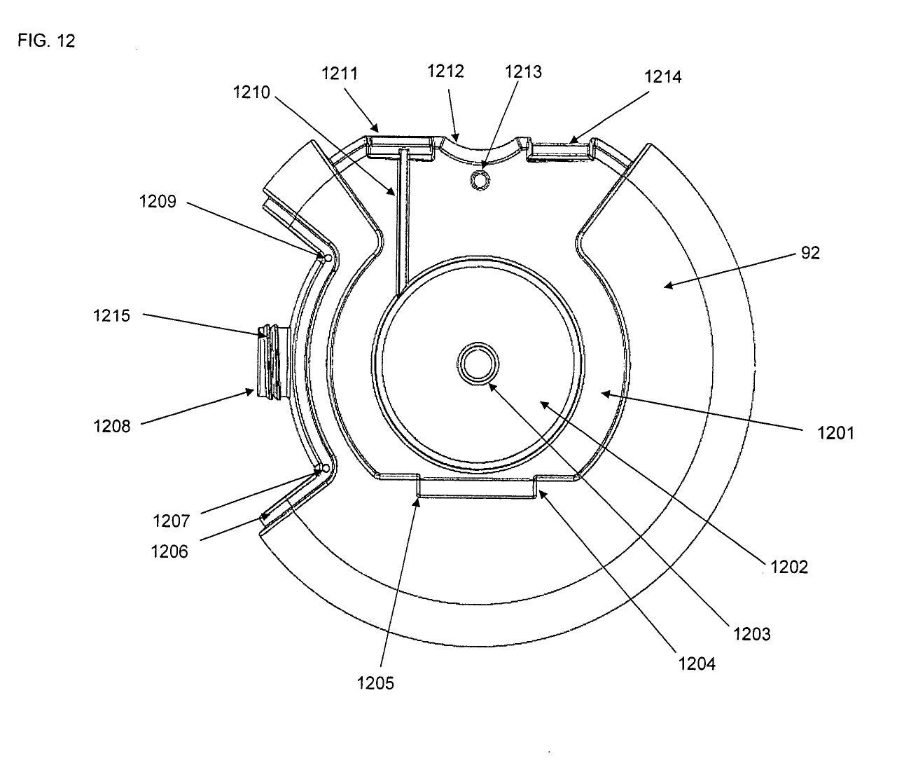

FIG. 12 is a side view of the main body 92 and illustrates many features which enable the transportation and dispensing of dental floss. Circular chamber 1202 is recessed into surface 1201 of main body 92 and designed to accommodate a spool of dental floss. Circular spool holder 1203 extends outward from circular cavity 1202 and is sized to fit into the inner opening of a dental floss spool. As such, a dental floss spool can rotate around circular spool holder 1203 to dispense dental floss. Canal 1210 is set into the main body so dental floss on a spool in cavity 1202 can travel out of cavity 1202, along canal 1210, and exit the main body 92 at feature 1211. Features of chamber cover 95, to be described in turn, match features 1211, 1213, and 1214 of main body 92, and enable dental floss to be secured and dispensed. Indented feature 1212 is shaped to facilitate a user's fingers picking up dental floss when the hygiene dispenser 91 is fully assembled. Indented points 1204 and 1205 serve as attach points for chamber cover 95, and enable chamber cover 95 to rotate toward and away from main body 92 to provide access to circular cavity 1202. This enables dental floss spools to be removed when all of the dental floss has been used, and new dental floss spools to be inserted, for example. Circular indenture 1213 matches a feature on chamber cover 95 which enables chamber cover 95 to be secured in a closed position against surface 1201 and over circular cavity 1202, thereby creating a closed chamber.

Also visible in FIG. 12 are features associated with the second chamber designed to store and dispense liquid (to be described in turn). Opening 1208 leads to a cavity fully enclosed in the main body 92, where liquid can be stored. Opening 1208 also serves as an area through which liquid can be refilled. Ridges 1215 on opening 1208 enable a nozzle or cap to be secured to the main body 92, thereby creating a fully sealed chamber. It should be understood that a number of methods for securing and dispensing a liquid are possible, e.g., standard screw top cap, two-part “sport” nozzle that can move back and forth to open and close, etc., as the invention is not limited in this respect. Surface 1206 is recessed so pull off cap 93 can fit flush with the outer surface of main body 92. Indented points 1207 and 1209 match features in pull off cap 93 and enable pull off cap 93 to be secured to the main body 92.

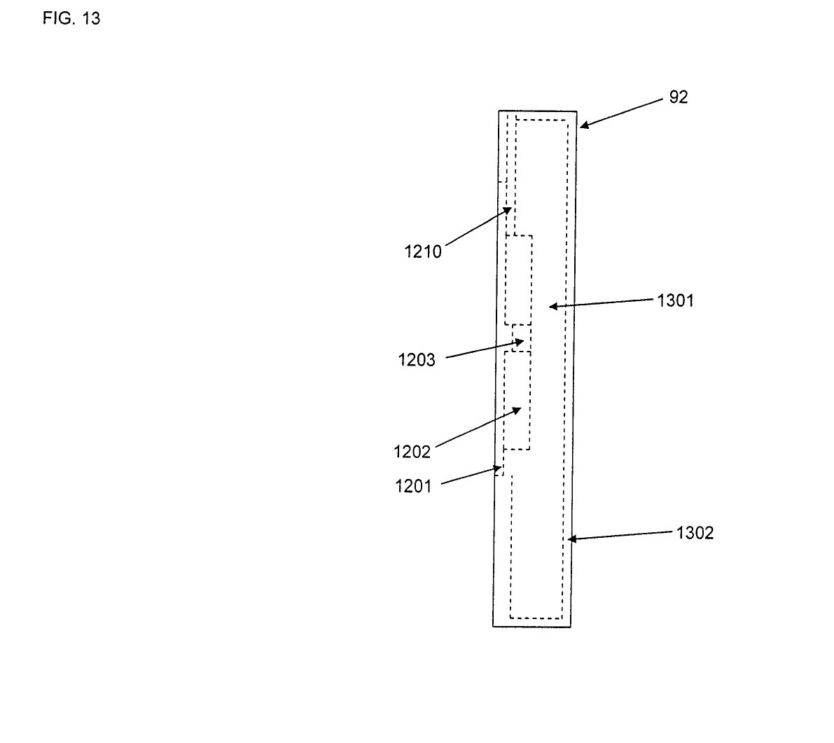

FIG. 13 shows a partial cross section of main body 92. In this view, the shape and location of cavity 1301 can be appreciated. When in an unsealed or open position, liquid contained in cavity 1301 can flow out of the chamber through opening 1208 as previously described. In one embodiment, chamber wall 1302 is made of a flexible material, such as plastic, which in areas around cavity 1301 a user of the product can squeeze to facilitate the dispensing of the liquid. Also in this side view it can be appreciated how a spool of dental floss can be placed around circular spool holder 1203 and secured in circular cavity 1202. Chamber cover 95 is sized so that it fits flush against recessed surface 1201, creating a closed chamber for transporting and dispensing dental floss. As previously described, canal 1210 provides a means for floss to exit main body 92.

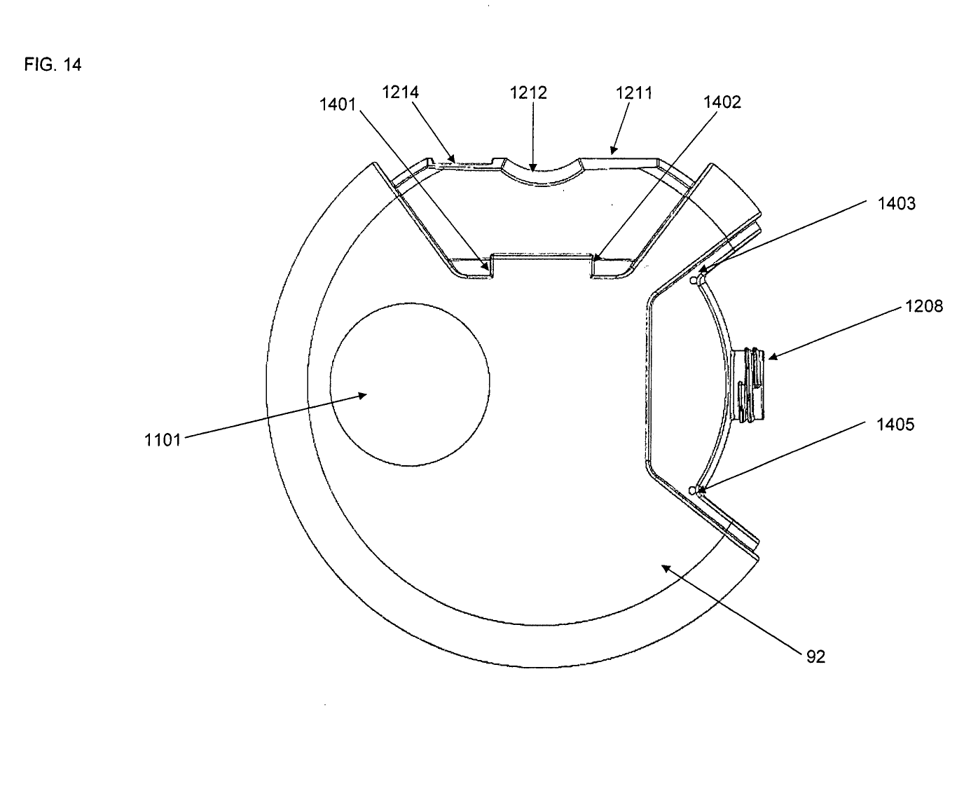

FIG. 14 shows the second side of main body 92. In this view, indented points 1401 and 1402 are visible. These points match features of hinged cap 94 and enable hinged cap 94 to be secured to main body 92. Indented feature 1101, previously described, serves to indicate a pressure point to facilitate the dispensing of liquid, although such a feature is not required. Indented points 1403 and 1405, like indented points 1207 and 1209 on the opposite side of main body 92, provide attachment points for securing pull off cap 93 to main body 92.

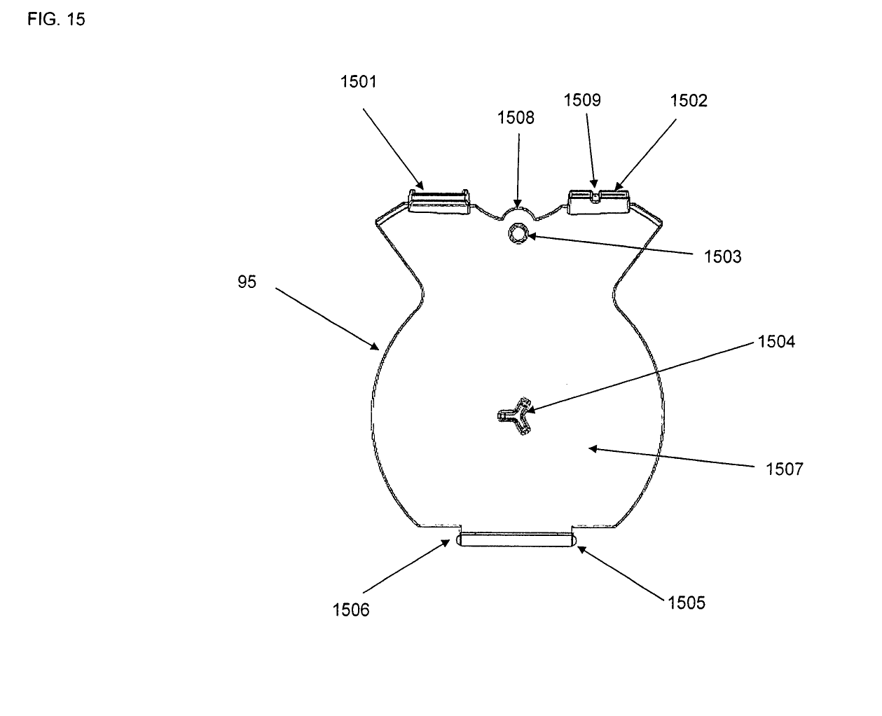

FIG. 15 shows the front view of chamber cover 95. Nubs 1505 and 1506 match indented points 1204 and 1205 and enable chamber cover 95 to attach to main body 92. Feature 1508 is raised slightly to enable a user of the product to open chamber cover 95 when chamber cover 95 is in the closed position, for example to replace a dental floss spool. In this embodiment, feature 1504 extends out from surface 1507 and matches circular spool holder 1203, enabling the dental floss spool to be secured inside circular cavity 1202. It should be understood that alternative arrangements, such as omitting feature 1504 and lengthening circular spool holder 1203, could be employed to secure the spool of dental floss. Nub 1503 extends out from surface 1507 and matches indented point 1213 on main body 92, as previously described, enabling chamber cover 95 to be secured in a closed position, creating a sealed chamber around the spool of dental floss. Feature 1502 is designed to sit above area 1211. A slot 1509 incorporated into feature 1502 secures the dental floss against the main body 92 while enabling the dental floss to travel out of canal 1210. Flat surface 1501 is designed to accommodate a metal dental floss cutter, similar to those employed in existing dental floss dispensers. When chamber cover 95 is secured to main body 92 and closed above circular cavity 1202 containing a spool of dental floss, dental floss travels along canal 1210, is held in place in area 1501, travels out of slot 1509, across and above indented feature 1212, and is secured in a floss cutter attached to flat surface 1501.

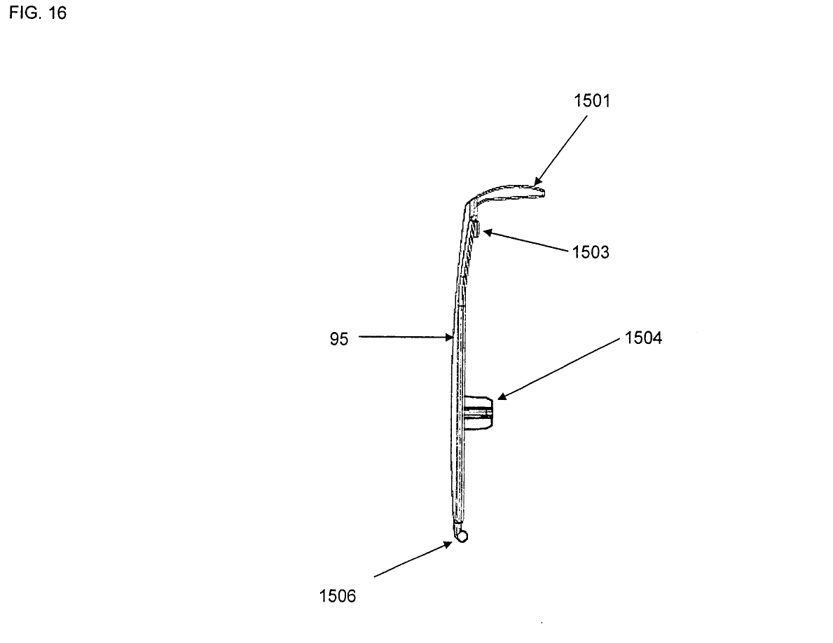

FIG. 16 shows a side view of same chamber cover 95.

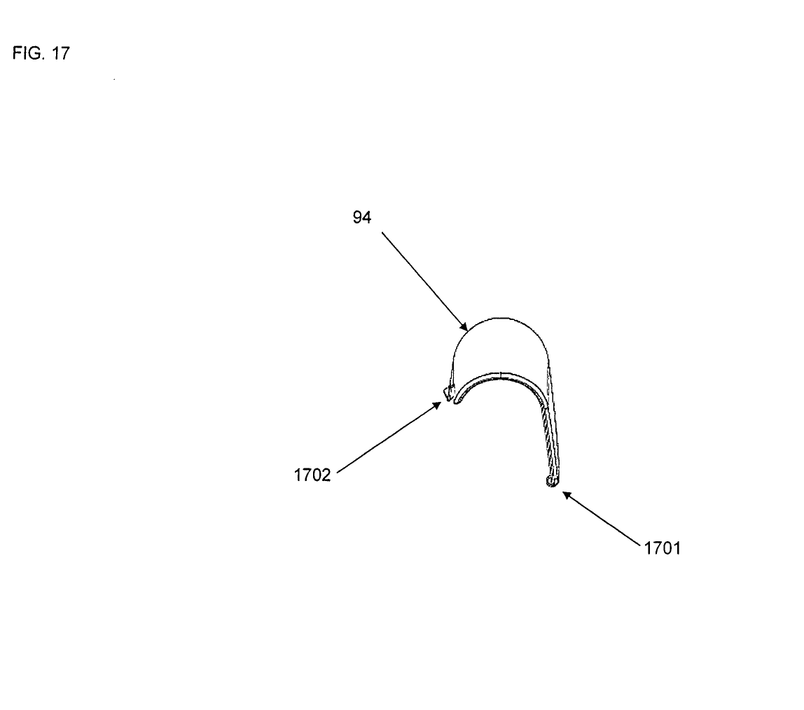

FIG. 17 shows a side view of hinged cap 94. Protruding nub 1701 matches indented point 1401 on main body 92 enabling the cap to be secured to main body 92. When in the closed position, raised feature 1702 sits slightly above curved feature 1508, enabling a user to lift hinged cap 94 upward, thereby providing access to the dental floss.

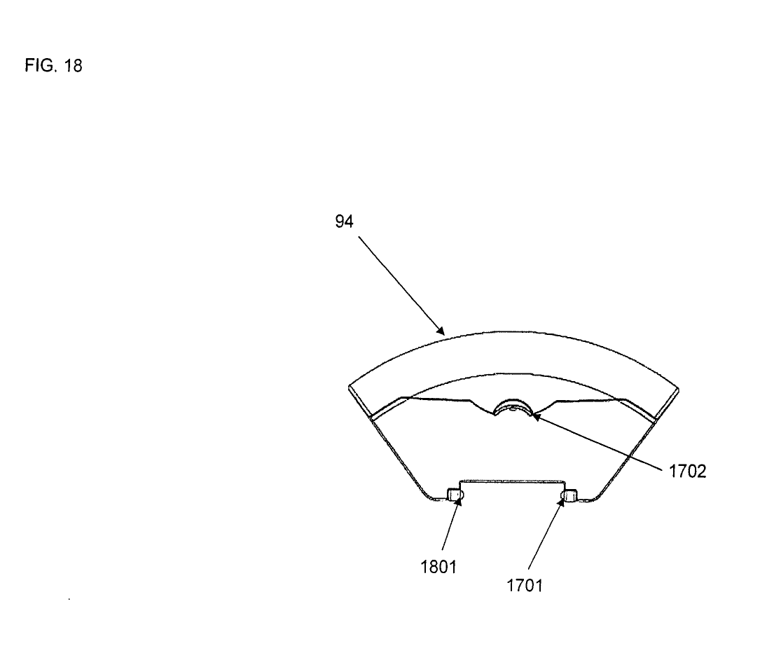

FIG. 18 shows a front view of hinged cap 94. Like protruding nub 1701, protruding nub 1801 matches indented point 1402 on main body 92, enabling hinged cap 94 to be secured to main body 92.

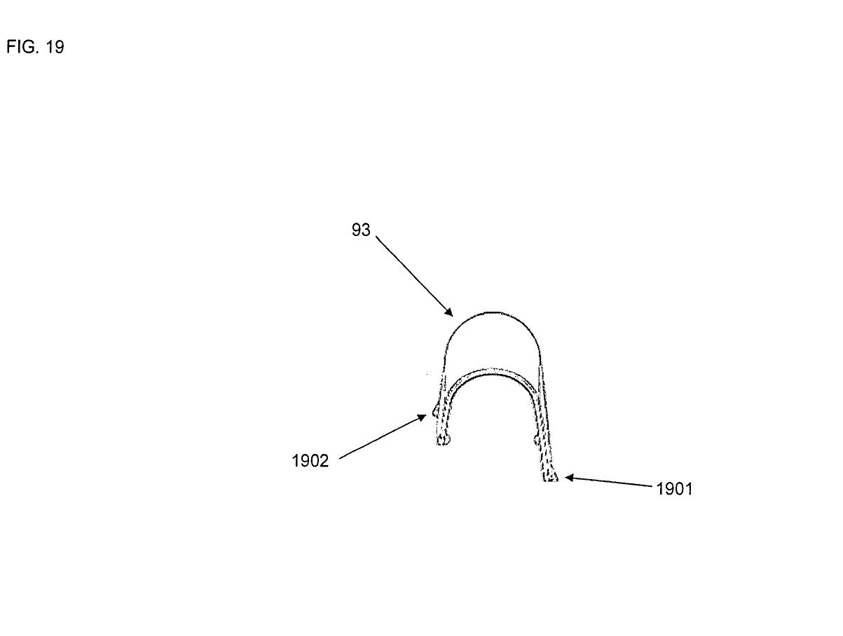

FIG. 19 shows a side view of pull off cap 93. When attached, raised features 1902 and 1901 sit slightly above the surface of main body 92, enabling the cap to be easily removed, thereby providing access to the cap and chamber containing liquid.

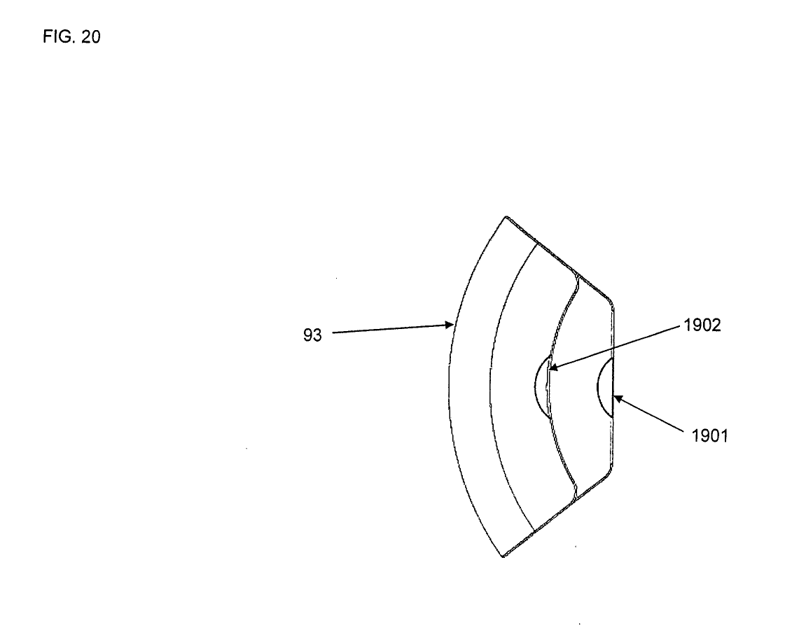

FIG. 20 shows a front view of same pull off cap.

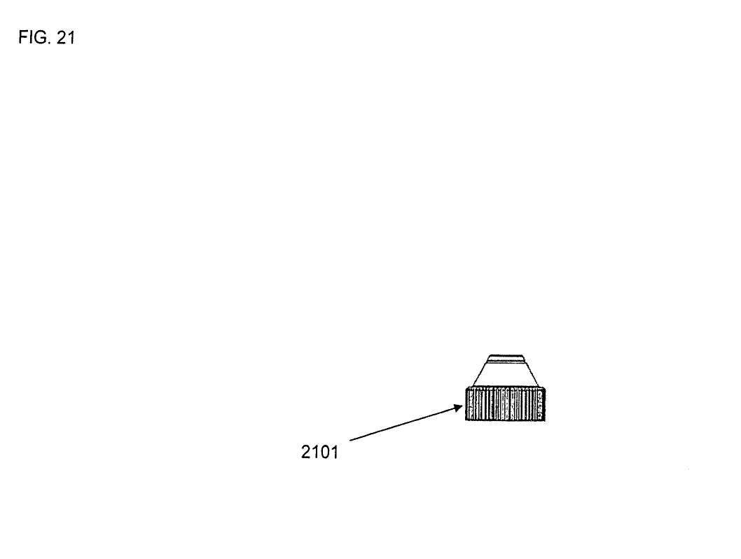

FIG. 21 shows a front view of screw-on cap 2101. While the embodiment of FIGS. 9-24 includes a closed cap that is unscrewed to enable access to the chamber containing liquid, alternative arrangements are envisioned, e.g., using a sport nozzle that, for example, pulls outward to enable liquid to flow through it, an open nozzle with corresponding closure incorporated into pull off cap, etc.

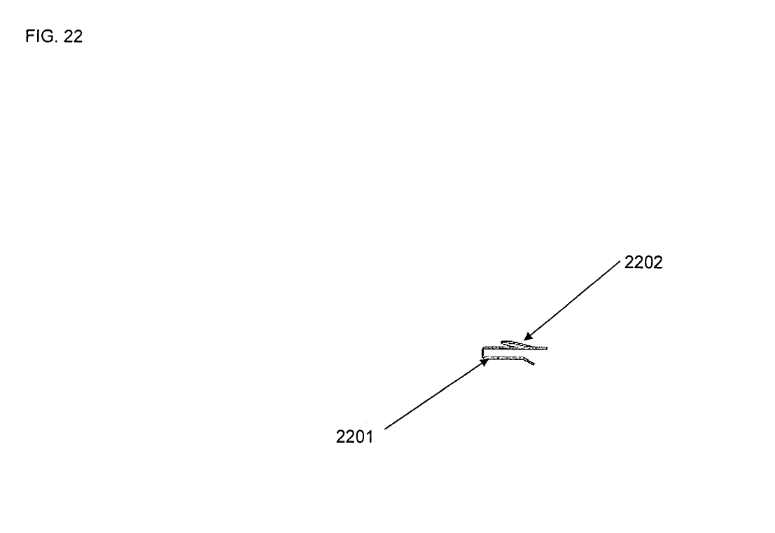

FIG. 22 shows a side view of the floss cutter 2201. Like floss cutters currently used in dental floss dispensers, in one embodiment, the bottom section of floss cutter 2201 is in the shape of a clip, enabling it to fit around an edge, in this case plastic ridge 1501. The top portion of floss cutter 2201 includes a raised edge 2202 to facilitate the cutting of dental floss. It should be appreciated that alternate mechanisms to cut the floss can be employed, as the invention is not limited to use of any particular mechanism.

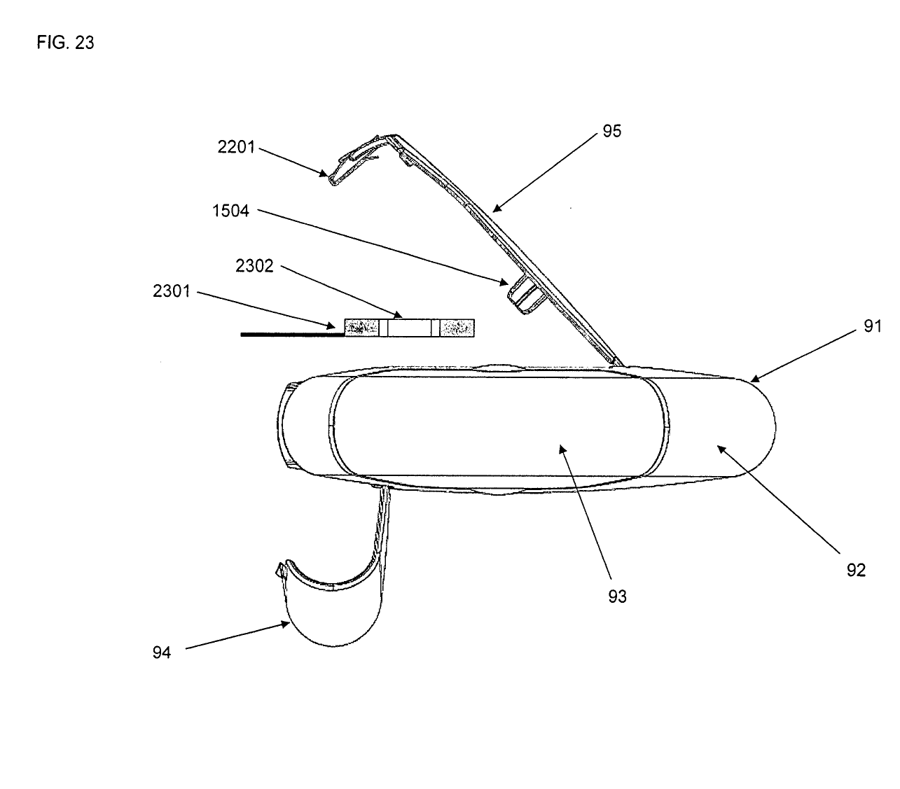

FIG. 23 shows an exploded side view of the main components of the dispenser 91. Pull off cap 93 is shown in an attached, closed position. In this view, hinged cap 94 is secured to main body 92, but in the open position. Chamber cover 95 is secured to main body 92 and in the open position. A spool of dental floss 2301 is illustratively shown in a position conducive to inserting it into circular cavity 1202 as previously described. The open center of the dental floss spool 2302 will fit around feature 1504 as previously described to enable the dental floss spool to rotate and dispense floss. Floss cutter 2201 is attached to chamber cover 95 on plastic ridge 1501 as previously described.

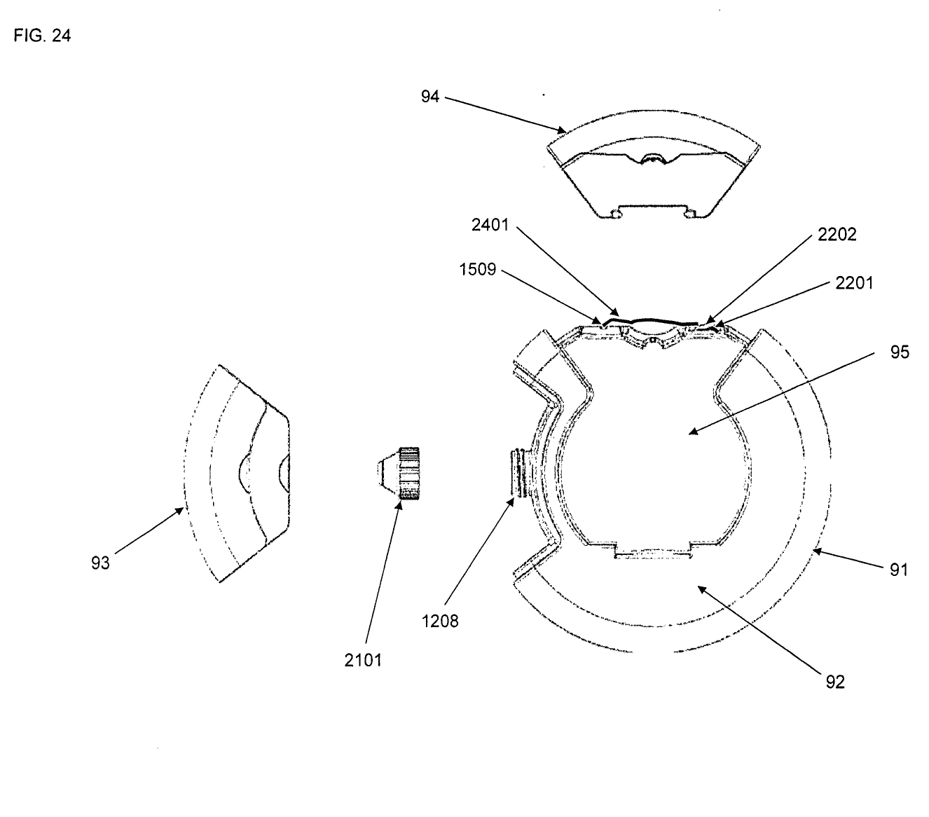

FIG. 24 shows a second exploded view of the main components of dispenser 91. In this view chamber cover 95 is shown in the closed position. Dental floss 2401 extends out of slot 1509 on chamber cover 95 and is secured in the floss cutter 2201 at raised ridge 2202. Hinged cap 94 is shown fully detached from main body 92. To seal and close the chamber which will contain liquid, screw on cap 2101 is screwed onto opening 1208, and cover 93 is pushed closed against main body 92.

It should be appreciated that the present invention is not limited to the three embodiments described above as other configurations for creating two or more separate chambers for transporting two or more different hygiene products are possible.

As should be appreciated from the foregoing, one embodiment of the invention is directed to a portable dispenser comprised of at least two separate chambers that each can be sealed separately to contain and transport a liquid mouth rinse or a teeth cleaning tool. A closure mechanism for each chamber can be incorporated into or attached to the dispenser.

Another embodiment of the invention is directed to a portable dispenser comprised of at least two separate chambers that each can be sealed separately to contain and transport a liquid mouth rinse or a teeth cleaning tool. In this second embodiment, features related to the transport of a teeth cleaning tool can be incorporated into the body of the dispenser that is integral with the chamber designed to contain and transport a liquid mouth rinse.

Another embodiment is directed to a portable dispenser comprised of two separate chambers. One chamber may be fully sealed to contain and transport liquid and may have a feature that facilitates dispensing the liquid, refilling the liquid and resealing the chamber (e.g., a removable cap). The second chamber may be designed to enclose dental floss, and may include features incorporated into the chamber design to facilitate the transportation, refilling or dispensing of dental floss (e.g., a cylindrical spool holder and a wedge, serration or other cutter for cutting the dental floss).

It should be appreciated that there are numerous uses for the embodiments of the present invention described herein. One example is for use by students that head off to school for a day and then return home. Aspects of the present invention can be employed to enable the student to take along a portable mouth cleansing apparatus (e.g., taking any of the forms described above or variations thereof) to school and using the apparatus to cleanse the student's mouth (e.g., after lunch or at another time) prior to returning home. In accordance with embodiments of the present invention that are disposable, the apparatus can be disposed of after a single use, whereas embodiments of the present invention that are adapted for multiple uses (e.g., refillable with a mouth rinse, able to add new spools of floss, etc.) can be taken back home by the student.

In addition to students, others can make use of a portable mouth cleansing apparatus in accordance with embodiments of the present invention. For example, a person leaving for the day (e.g., from their home, a hotel room or other place where they will return to go to sleep) may take along a portable mouth cleansing apparatus for use during the day prior to returning.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and equivalents thereto.

What is claimed is:

1. An apparatus comprising:
at least one teeth cleaning tool;
a volume of mouth rinse; and
a container comprising;
at least one first chamber that is liquid-tight and has the volume of mouth rinse disposed therein; and
at least one second chamber having the at least one teeth cleaning tool at least partially disposed therein.

2. The apparatus of claim 1, wherein the at least one teeth cleaning tool comprises dental floss.

3. The apparatus of claim 1, wherein the apparatus is portable and the container has no dimension greater than four inches.

4. The apparatus of claim 1, wherein the container comprises:
a body having at least one surface that defines at least a portion of the at least one first chamber and comprises an outlet; and
a cap that is removably attachable to the body to form liquid tight seal that closes the outlet.

5. The apparatus of claim 4, wherein the body further defines at least a portion of the second chamber.

6. The apparatus of claim 5, wherein the container further comprises at least one door that closes the second chamber and can be opened to provide access to the at least one tooth cleaning tool.

7. The apparatus of claim 5, wherein the container further comprises at least one cap that that at least partially closes the second chamber and can be at least partially detached from the body to provide access to the at least one tooth cleaning tool.

8. The apparatus of claim 7, wherein the at least one tooth cleaning tool is removably attached to the cap.

9. The apparatus of claim 8, wherein the at least one teeth cleaning tool comprises dental floss.

10. The apparatus of claim 1, wherein the at least one tooth cleaning tool is removably attached to the container.

11. The apparatus of claim 1, wherein the apparatus is disposable.

12. The apparatus of claim 1, wherein the volume of mouth rinse comprises a mouthful or less.

13. The apparatus of claim 2, wherein the dental floss comprises no more than 20 inches of dental floss.

14. The apparatus of claim 1, wherein the container comprises:
a body having at least one surface that defines at least a portion of the at least one first chamber, the body having at least a portion thereof that is constructed to be torn or otherwise broken to provide access to the volume of mouth rinse.

15. The apparatus of claim 1, wherein the mouth rinse comprises a viscosity below 100 centipoise.

16. A method of cleansing the mouth of a person, the method comprising acts of:
(A) taking a portable mouth cleansing apparatus along with the person when the person leaves a location to which the person will return to go to sleep the next time the person goes to sleep, the mouth cleaning apparatus comprising a volume of mouth rinse and at least one teeth cleaning tool; and
(B) while away from the location to which the person will return to go to sleep, using the apparatus to cleanse the person's mouth by;
rinsing the person's mouth with at least some of the volume of mouth rinse; and/or
using the at least one teeth cleaning tool to at least partially clean the person's teeth.

17. The method of claim 16, wherein the at least one teeth cleaning tool comprises dental floss.

18. The method of claim 16, wherein the act (B) comprises a single use of the apparatus, and wherein the method further comprises disposing of the apparatus after the single use in the act (B).

19. The method of claim 16, further comprising an act of, prior to the person going to sleep after the act (B), taking the portable mouth cleansing apparatus along with the person back to the location to which the person returns to go to sleep.

20. A method of cleansing the mouth of a student attending school for a portion of a day and then returning to the student's home, the method comprising acts of:
(A) taking a portable mouth cleansing apparatus along with the student when the student leaves the student's home for school, the mouth cleaning apparatus comprising a volume of mouth rinse and at least one teeth cleaning tool; and
(B) while at school, using the apparatus to cleanse the student's mouth by;
rinsing the student's mouth with at least some of the volume of mouth rinse; and/or
using the at least one teeth cleaning tool to at least partially clean the student's teeth.

21. The method of claim 20, wherein the at least one teeth cleaning tool comprises dental floss.

22. The method of claim 20, wherein the act (B) comprises a single use of the apparatus, and wherein the method further comprises disposing of the apparatus after the single use in the act (B).

23. The method of claim 20, further comprising an act of taking the portable mouth cleansing apparatus back to the student's home when the student returns home after school.
